(19) United States
(12) Patent Application Publication
(10) Pub. No.: US 2005/0174038 A1
(43) Pub. Date: Aug. 11, 2005

(54) Panel for field emission type backlight device and method of manufacturing the same

(76) Inventors: Hang-woo Lee, Suwon-si (KR); Jong-min Kim, Suwon-si (KR); Shang-hyeun Park, Boryeong-si (KR); Jae-eun Jung, Seoul (KR); Tae-sik Oh, Suwon-si (KR)

Correspondence Address: MCGUIREWOODS, LLP, 1750 TYSONS BLVD, SUITE 1800, MCLEAN, VA, 22102, US

(21) Appl. No.: 11/032,211

(22) Filed: Jan. 11, 2005

(30) Foreign Application Priority Data
Feb. 5, 2004 (KR) 2004-0007525

(51) Int. Cl. H01J 1/62; H01J 63/04

(52) U.S. Cl. 313/495

(57) ABSTRACT

A panel for a field emission type backlight device may include a substrate having a plurality of grooves formed on a side of it. The grooves can serve to diverge incident light. An anode electrode and a fluorescent layer may be provided sequentially on the same side of the substrate.

This application claims the priority of Korean Patent Application No. 2004-7525, filed on Feb. 5, 2004, which is incorporated herein in its entirety by reference.

### BACKGROUND OF THE INVENTION

(a) Field of the Invention

The present invention relates, inter alia, to a field emission type backlight device, and more particularly, to a field emission type backlight device that has improved luminance uniformity and light efficiency by increasing a light emitting area. Additionally, the present invention relates to a field emission type backlight device that can be manufactured with a reduced production cost.

(b) Description of Related Art

Generally there are two types of flat panel displays: emissive displays and non-emissive displays. Examples of emissive displays include a cathode ray tube (CRT), a plasma display panel (PDP), and a field emission display (FED). An example of a non-emissive display is a liquid crystal display (LCD). An LCD typically has relatively light weight and low power consumption. However, an LCD's image cannot be observed in a dark place because the LCD is a non-emissive display in which images are produced not by self-emitting but by external light. To overcome this, a backlight device may be provided in a rear side of the LCD.

A cold cathode fluorescent lamp (CCFL) has been used as a line light source and a light emitting diode (LED) has been used as a point light source. However, such conventional backlight devices have high production cost (due to the complexity of their structure) and high power consumption for reflecting and transmitting light (since a light source may be located laterally). Particularly, it may be difficult to obtain a uniform luminance when an LCD becomes large.

Recently, a field emission type backlight device with a surface emission structure has been proposed to solve the above-mentioned problems. Such a field emission type backlight device may have low power consumption and a relatively uniform luminance even in a wide light emitting region compared to a conventional backlight device. It may be helpful to understand the generalities of a field emission type backlight device.

As shown in FIG. 1, upper and lower substrates 21 and 11 may be disposed facing each other with a predetermined gap therebetween. An anode electrode 23 and a fluorescent layer 25 may be sequentially provided on a lower side of the upper substrate 21, and a cathode electrode 13 that may function as an electron emission source may be provided on an upper side of the lower substrate 11. A diffuser 30 for improving luminance uniformity may be provided above the upper substrate 21.

In such a structure, when a predetermined voltage is applied between the anode electrode 23 and the cathode electrode 13, electrons may be emitted from the cathode electrode 13. When the emitted electrons collide against a fluorescent layer 25 on the upper substrate 21, a visible light may be produced and emitted through the upper substrate 21. When the visible light emitted from the upper substrate 21 passes through the diffuser 30, a visible light of a relatively uniform luminance may emerge from the diffuser 30.

In a field emission type backlight device of such a structure, however, if a diffuser 30 is provided for improving luminance uniformity, the production cost may increase and the diffuser 30 may decrease light efficiency.

### SUMMARY OF THE INVENTION

The present invention provides, for example, a field emission type backlight device that has improved luminance uniformity and light efficiency. The present invention also provides, for example, a field emission type backlight device that has increased light emitting area and can be cheaply manufactured.

A panel for a field emission type backlight device can include a substrate having one side a plurality of grooves formed to diverge incident light. It may also include an anode electrode and a fluorescent layer sequentially provided on one side of the substrate.

The groove may have a substantially hemispherical shape. The substrate may be made of a transparent material.

Another field emission type backlight device can include an upper panel with an upper substrate that has on a lower side a plurality of grooves formed to diverge incident light. It can also include an anode electrode and a fluorescent layer sequentially provided on a lower side of the upper substrate. It can further include a lower panel with a lower substrate disposed to face the upper substrate (with a predetermined gap between the two substrates) and a cathode electrode on an upper side of the lower substrate.

A panel for a field emission type backlight device can include a material layer provided on a substrate with a plurality of grooves on the surface to diverge incident light. It may also include an anode electrode and a fluorescent layer sequentially provided on a surface of the material layer. The material layer may be made of a transparent insulating material or a photosensitive insulating material.

Another field emission type backlight device can include an upper panel with an upper substrate, a material layer on a lower side of the upper substrate. The material layer may have a surface with a plurality of grooves formed to diverge incident light. The device can also include an anode electrode and a fluorescent layer sequentially provided on a surface of the material layer. It can additionally include a lower panel with a lower substrate facing the upper substrate (with a predetermined gap between the two substrates) and a cathode electrode on an upper side of the lower substrate.

A method for manufacturing a panel for a field emission type backlight device may include preparing a substrate, forming an etch mask of a predetermined shape on one side of the substrate, forming a plurality of grooves on one side of the substrate by etching the substrate exposed through the etch mask, and providing an anode electrode and a fluorescent layer sequentially on one side of the substrate.

Forming an etch mask may include applying a photoresist on one side of the substrate and patterning the photoresist in a predetermined shape by photolithography. The etching of the substrate may be by wet or dry etching.

The groove may have a substantially hemispherical shape and may be formed by isotropically etching the substrate exposed through the etch mask.

Another method of manufacturing a panel for a field emission type backlight device may include preparing a substrate, providing a predetermined material layer on the substrate, forming an etch mask of a predetermined shape on a surface of the material layer, forming a plurality of grooves on a surface of the material layer by etching the material layer exposed through the etch mask, and providing an anode electrode and a fluorescent layer sequentially on a surface of the material layer.

The material layer may be applied using, for example, a printing method or a spin coating method and be made of a transparent insulating material.

Another method of manufacturing a panel for a field emission type backlight device may include preparing a substrate, providing a predetermined material layer on the substrate, forming a plurality of grooves on a surface of the material layer by patterning the material layer by photolithography; and providing an anode electrode and a fluorescent layer sequentially on a surface of the material layer.

The material layer may be made of a photosensitive insulating material.

### BRIEF DESCRIPTION OF THE DRAWINGS

FIG. 1 is a partial sectional view showing a structure of a conventional field emission type backlight device.

FIG. 2 is a partial sectional view showing a structure of a field emission type backlight device of an embodiment of the present invention.

FIG. 3 is a partial perspective view showing a lower side of an upper substrate shown in FIG. 2.

FIG. 4 is a sectional view showing the structure of a field emission type backlight device of another embodiment of the present invention.

FIG. 5 is a partial perspective view showing an upper substrate and a lower side of the material layer shown in FIG. 4.

FIGS. 6A, 6B, 6C, 6D, 6E, and 6F are sectional views illustrating a method of manufacturing the upper panel shown in FIG. 2.

FIGS. 7A, 7B, 7C, 7D, 7E, and 7F are sectional views illustrating a method of manufacturing the upper panel shown in FIG. 4.

FIGS. 8A, 8B, 8C, and 8D are sectional views illustrating another method of manufacturing the upper panel shown in FIG. 4.

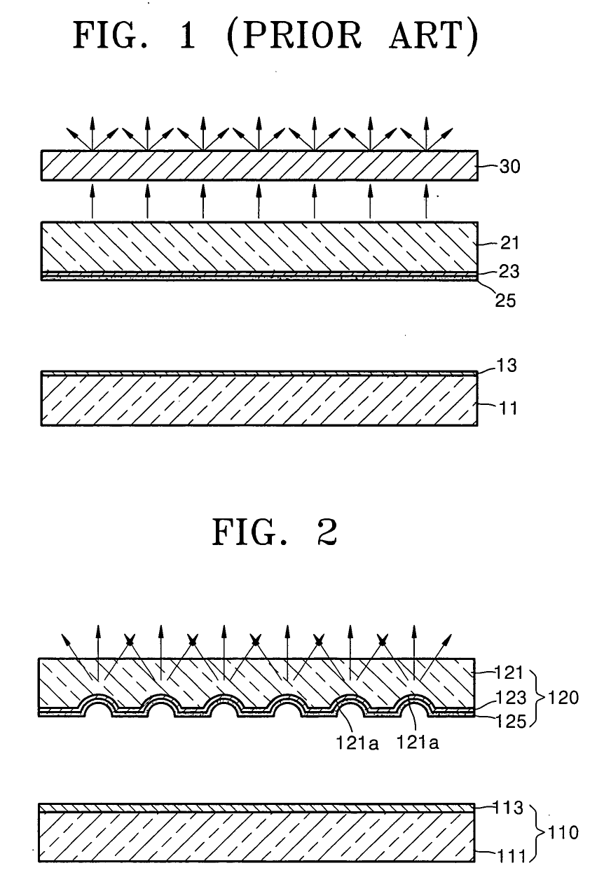

### DETAILED DESCRIPTION OF THE INVENTION

Exemplary embodiments of the present invention will now be described in detail with reference to the accompanying drawings. Like reference numerals in the drawings denote like elements.

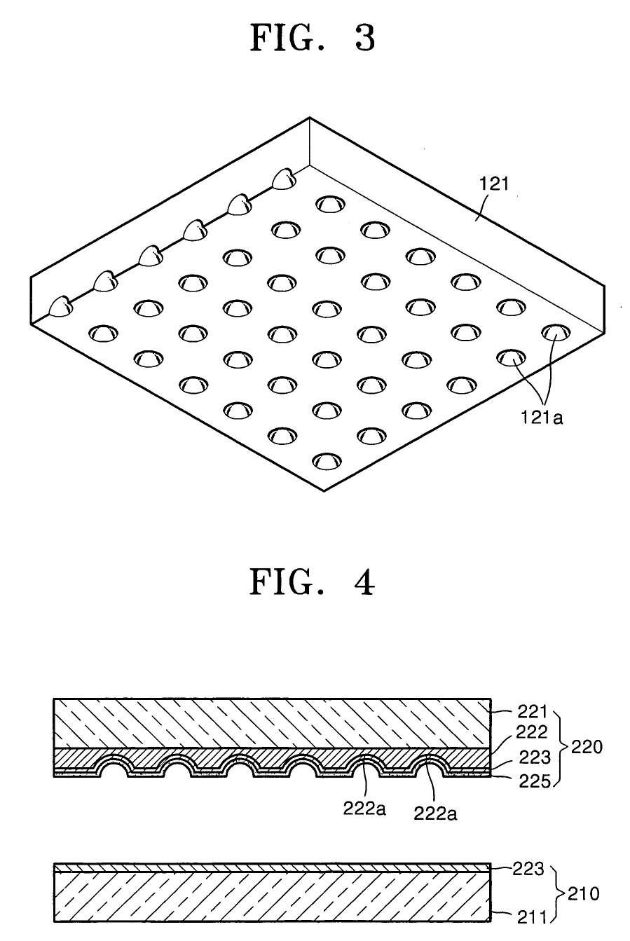

As shown in FIGS. 2 and 3, a field emission type backlight device of an embodiment of the present invention may include upper and lower panels 120 and 110 facing each other.

The upper panel 120 may include an upper substrate 121, an anode electrode 123 on a lower side of the upper substrate 121, and a fluorescent layer 125 on a lower side of the anode electrode 123. The lower panel 110 may include a lower substrate 111 and a cathode electrode 113 on an upper side of the lower substrate 111.

The upper substrate 121 may be made of a transparent substance such as glass. A plurality of grooves 121A may be formed on a lower side of the upper substrate 121. The grooves 121A may function to increase the area of the fluorescent layer 125 on a lower side of the upper substrate 121 and to diverge visible light from the fluorescent layer 125. Therefore, when the grooves 121A are formed on a lower side of the upper substrate 121, it may be possible to improve not only light efficiency (due to the increase in a light emitting area) but also luminance uniformity. Although the grooves 121A can be formed in various shapes, it may be preferable that the grooves 121A be formed in a substantially hemispherical shape as shown, by way of example (not definition), in FIG. 3.

The anode electrode 123 can be provided in a thin film on the entire lower side of the upper substrate 121. The anode electrode 123 may be made of indium tin oxide (ITO) (a transparent conductive material). Thus visible light from the fluorescent layer 125 may be transmitted.

The fluorescent layer 125 may be provided on the entire lower side of the anode electrode 123 and may be made of fluorescent materials R, G, and B. A fluorescent layer 125 may be provided either by applying each of fluorescent materials R, G, and B on a lower side of the anode electrode 123 in a predetermined pattern or, for another example, by applying a mixture of fluorescent materials R, G, and B on the entire lower side of the anode electrode 123.

The lower substrate 111 may face the upper substrate 121 with a predetermined gap between the two substrates. The lower substrate 111 may include a transparent substrate such as a glass substrate.

A cathode electrode 113 (which can serve as an electron emission source) may be provided on an upper side of the lower substrate 111. The cathode electrode 113 may be provided in a thin film on the entire upper side of the lower substrate 111, or, for another example, in a predetermined pattern such as a stripe pattern on an upper side of the lower substrate 111. The cathode electrode 113 may be made of ITO (a conductive material). The cathode electrode 113 may include material for improving electron emission such as carbon is nanotube (CNT).

In a field emission type backlight device having the above-mentioned structure, when a predetermined voltage is applied between the anode electrode 123 and the cathode electrode 113, the cathode electrode 113 may emit electrons. When these electrons collide with the fluorescent layer 125 on the upper substrate 121, visible light may be produced and emitted through the upper substrate 121. Visible light from the fluorescent layer 125 may diverge while passing through the plurality of grooves 121A on the lower side of the upper substrate 121. As a result, visible light having a uniform luminance may shine from an upper side of the upper substrate 121.

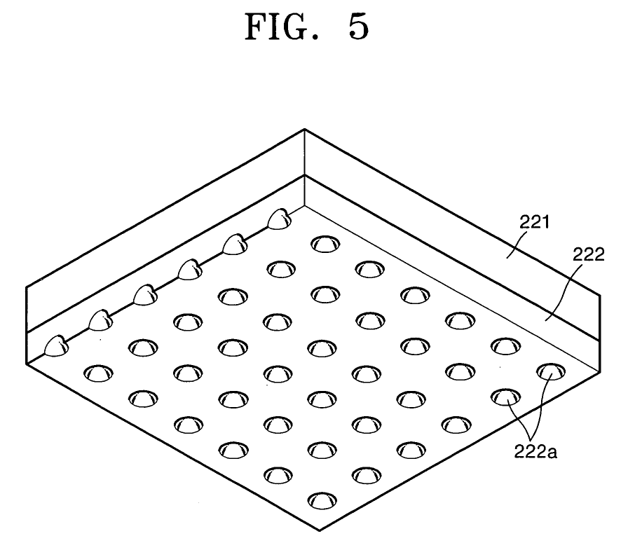

As shown in FIGS. 4 and 5, a field emission type backlight device of another embodiment of the present invention may include an upper panel 220 and a lower panel 210 facing each other.

The upper panel 220 may include an upper substrate 221, a predetermined material layer 222 on a lower side of the upper substrate 221, an anode electrode 223 on a lower side of the material layer 222, and a fluorescent layer 225 on a lower side of the anode electrode 223. The lower panel 210 may include a lower substrate 211 and a cathode electrode 213 on an upper side of the lower substrate 211.

The upper substrate 221 may be a transparent substrate such as a glass substrate. The material layer 222 may be a thick film on a lower side of the upper substrate 221. The material layer 222 may be a transparent insulating material or a photosensitive insulating material. A plurality of grooves 222A (which can diverge incident light) may be on a lower side of the material layer 222. The grooves 222A may increase the area of the fluorescent layer 225 on a lower side of the material layer 222 and may diverge incident visible light from the fluorescent layer 225.

Therefore, when grooves 222A are formed on a lower side of the material layer 222, it may be possible to improve not only light efficiency due to the increase in light emitting area but also to improve luminance uniformity. Although the grooves 222A can be formed in various shapes, it may be preferable that the grooves 222A are formed in a substantially hemispherical shape as shown, for example, in FIG. 5.

The anode electrode 223 can be provided in a thin film on the entire lower side of the material layer 222 where the grooves 222A are formed. The anode electrode 223 may be made of ITO. The fluorescent layer 225 may be on the entire lower side of the anode electrode 223 and may be made of fluorescent materials R, G, and B.

The lower substrate 211 may face the upper substrate 221 with a predetermined gap between the two substrates. The lower substrate 211 may be made of a transparent substrate such as a glass substrate. A cathode electrode 213 may be on an upper side of the lower substrate 211. The cathode electrode 213 may be made of ITO (a transparent conductive material). The cathode electrode 213 may include a material for improving electron emission such as CNT.

It may be possible to manufacture an upper panel for a field emission type backlight device of an embodiment of the present invention.

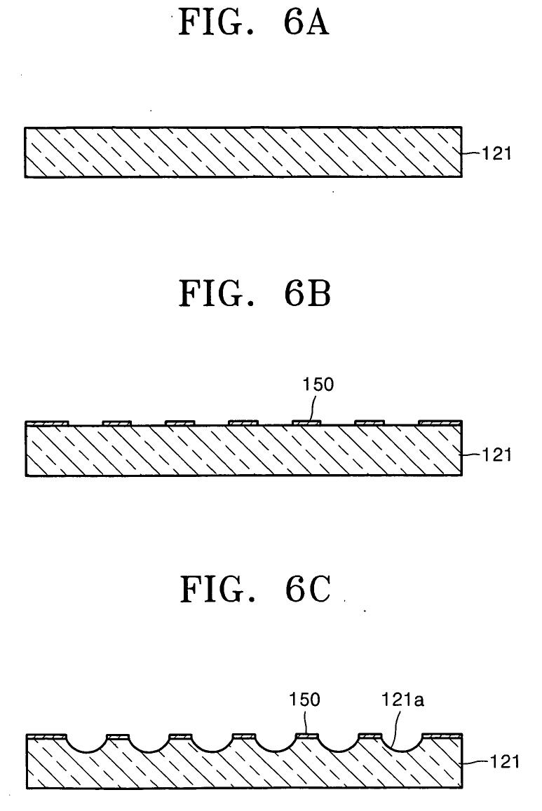

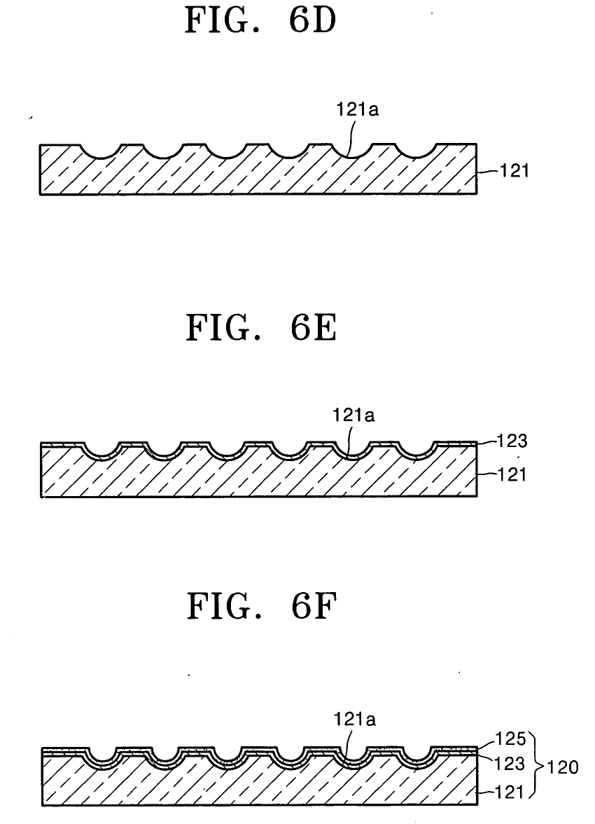

A flat substrate 121 may be prepared as shown in FIG. 6A. The substrate 121 may be a transparent substrate such as a glass substrate.

An etch mask 150 of a predetermined shape may be formed on one side of the substrate 121 as shown in FIG. 6B. The etch mask 150 may be formed by applying photoresist on one side of the substrate 121 and patterning the photoresist in a predetermined shape by photolithography.

Then, as shown in FIG. 6C, a plurality of grooves 121A may be formed on one side of the substrate 121 by etching the substrate 121 exposed through the etch mask 150. The etching of the substrate 121 may be wet or dry etching. Although the grooves 121A can be formed in various shapes, grooves 121A preferably may be substantially hemispherical. The hemispherical grooves 121A may be formed by isotropically etching the substrate 121 exposed through the etch mask 150.

After removing the etch mask 150 from the substrate 121 as shown in FIG. 6D, an anode electrode 123 may be provided on one side of the substrate 121 where the grooves 121A are formed as shown in FIG. 6E. The anode electrode 123 can be provided by depositing a transparent conductive material such as ITO on an entire side of the substrate 121 by sputtering.

Finally, as shown in FIG. 6F, an upper panel 120 for a field emission type backlight device can be completed by providing a fluorescent layer 125 on a surface of the anode electrode 123.

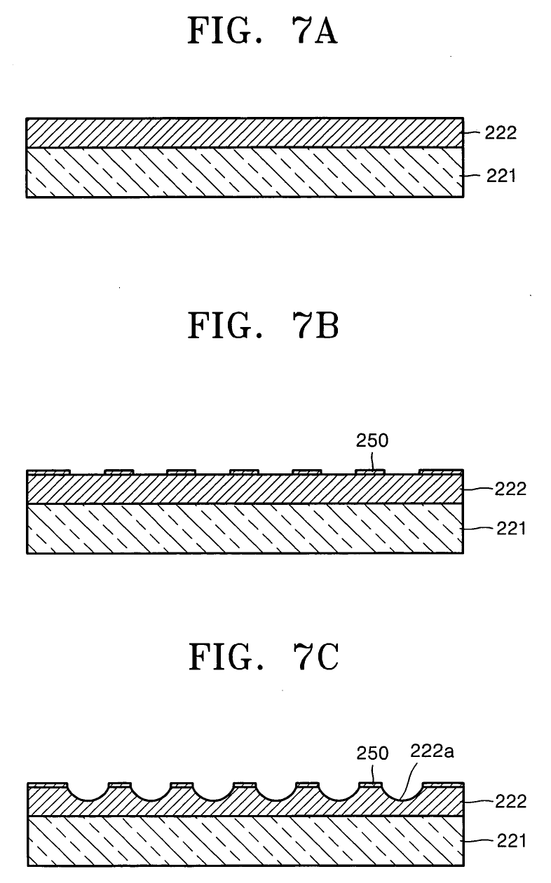

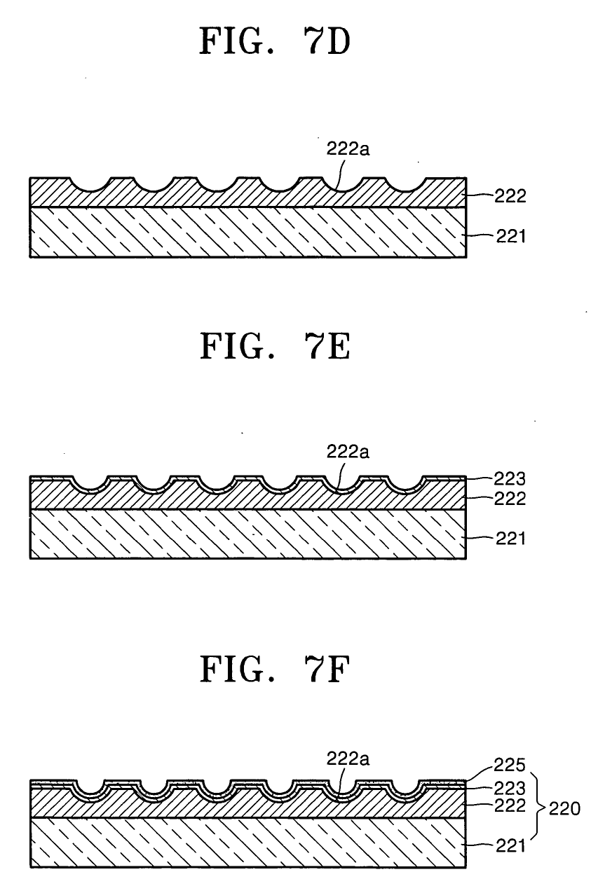

As shown in FIG. 7A, a predetermined material layer 222 may be formed as a thick film on one side of a substrate 221. The substrate 221 may be a transparent substrate such as a glass substrate. The material layer 222 may be a transparent insulating material. The material layer 222 may be formed by applying a transparent insulating material on one side of the substrate 221 by, for example, a printing method or a spin coating method.

Then, as shown in FIG. 7B, an etch mask 250 of a predetermined shape may be formed on a surface of the material layer 222. Specifically, the etch mask 250 may be formed by applying a photoresist on a surface of the material layer 222 and patterning the photoresist in a predetermined shape by photolithography.

Then, as shown in FIG. 7C, a plurality of grooves 222A may be formed on a surface of the material layer 222 by etching the material layer 222 exposed through the etch mask 250. The etching of the material layer 222 can be formed by wet or dry etching. Preferably, the grooves 222A may have a substantially hemispherical shape. The hemispherical grooves 222A may be formed by isotropically etching the material layer 222 exposed through the etch mask 250.

Then, after removing the etch mask 250 from the material layer 222 as shown in FIG. 7D, an anode electrode 223 may be provided on a surface of the material layer 222 where grooves 222A are formed as shown in FIG. 7E. The anode electrode 223 can be provided by depositing a transparent conductive material such as an ITO on an entire side of the material layer 222 by sputtering.

Finally, as shown in FIG. 7F, when a fluorescent layer 225 is provided on a surface of the anode electrode 223, the upper panel 220 for a field emission type backlight device is completed.

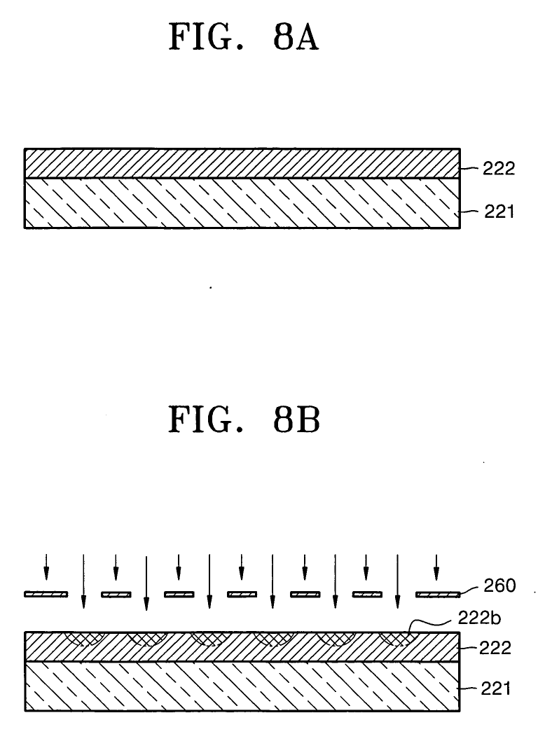

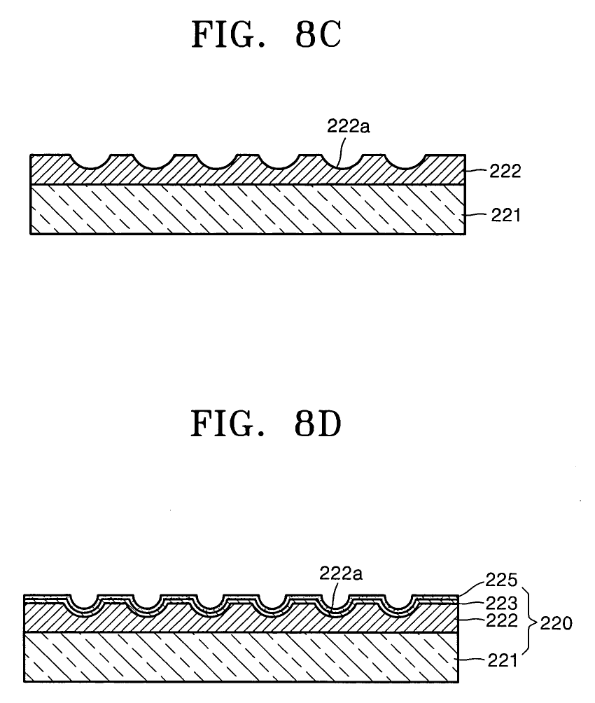

As shown in FIGS. 8A, 8B, 8C, and 8D, a predetermined material layer 222 may be formed as a thick film on one side of a substrate 221. The substrate 221 may be a transparent substrate such as a glass substrate. The material layer 222 may be a photosensitive insulating material. The material layer 222 may be provided by applying a photosensitive insulating material on one side of the substrate 221 by, for example, a printing method or a spin coating method.

Then, after providing a photomask 260 having a predetermined shape above the material layer 222, photolithography may be performed. Next, when the portion 222B exposed through the photomask 260 is removed, a plurality of grooves 222A may be provided on one side of the material layer 222, as shown in FIG. 8C. The grooves 222A may be formed in a substantially hemispherical shape by adjusting light intensity, exposure time, and so on.

Then, as shown in FIG. 8D, when the anode electrode 223 and the fluorescent layer 225 are sequentially provided on a surface of the material layer 222 where the grooves 222A are formed, the upper panel 220 for a field emission type backlight device is completed.

A panel for a field emission type backlight device and a method of manufacturing the same may make it possible to improve luminance uniformity by forming a plurality of grooves (which diverge incident light) on an upper substrate or material layer, and to improve light efficiency by increasing the light emitting area. Also, it may be possible to reduce manufacturing cost since a conventional diffuser is not required.

While exemplary embodiments of the present invention have been described, they should be considered in all respects as illustrative and various changes in form and details may be made therein without departing from the scope of the present invention.

1. A panel for a field emission type backlight device, comprising:
a substrate on a first side of which a plurality of grooves are formed to diverge incident light; and
an anode electrode and a fluorescent layer sequentially provided on the first side of the substrate.

2. The panel of claim 1, wherein the groove is substantially hemispherical.

3. The panel of claim 1, wherein the substrate comprises a transparent material.

4. A field emission type backlight device, comprising:
an upper panel comprising an upper substrate with a plurality of grooves on a lower side, and an anode electrode and a fluorescent layer sequentially provided on a lower side of the upper substrate; and
a lower panel including a lower substrate disposed to face the upper substrate with a predetermined gap therebetween and a cathode electrode provided on an upper side of the lower substrate,
wherein the grooves diverge incident light.

5. The field emission type backlight device of claim 4, wherein the groove is substantially hemispherical.

6. The field emission type backlight device of claim 4, wherein the upper substrate comprises a transparent material.

7. A panel for a field emission type backlight device, comprising:
a material layer on a substrate; and
an anode electrode and a fluorescent layer sequentially provided on the surface of the material layer,
the material layer having a surface in which a plurality of grooves are formed, and wherein the grooves can diverge incident light.

8. The panel of claim 7, wherein the grooves are substantially hemispherical.

9. The panel of claim 7, wherein the material layer comprises a transparent insulating material.

10. The panel of claim 7, wherein the material layer comprises a photosensitive insulating material.

11. A field emission type backlight device, comprising:
an upper panel comprising an upper substrate, a predetermined material layer on a lower side of the upper substrate, and an anode electrode and a fluorescent layer sequentially provided on a surface of the material layer; and
a lower panel comprising a lower substrate disposed to face the upper substrate with a predetermined gap between the upper substrate and the lower substrate, and a cathode electrode on an upper side of the lower substrate,
the predetermined material layer having a surface in which a plurality of grooves are formed, and wherein the grooves can diverge incident light.

12. The field emission type backlight device of claim 11, wherein the grooves are substantially hemispherical.

13. The field emission type backlight device of claim 11, wherein the material layer comprises a transparent insulating material.

14. The field emission type backlight device of claim 11, wherein the material layer comprises a photosensitive insulating material.

15. A method of manufacturing a panel for a field emission type backlight device, comprising:
forming an etch mask of a predetermined shape on a first side of a substrate;
forming a plurality of grooves on the first side of the substrate by etching the substrate exposed through the etch mask; and
depositing an anode electrode and a fluorescent layer sequentially on the first side of the substrate.

16. The method of claim 15, wherein forming of the etch mask comprises:
applying a photoresist on the first side of the substrate; and
patterning the photoresist in a predetermined shape by photolithography.

17. The method of claim 15, wherein the substrate is etched by at least one of a group of wet etching and dry etching.

18. The method of claim 15, wherein the grooves are substantially hemispherical shape.

19. The method of claim 15, wherein forming the plurality of grooves comprises isotropically etching the substrate exposed through the etch mask.

20. A method of manufacturing a panel for a field emission type backlight device, comprising:
depositing a material layer on a substrate;
forming an etch mask of a predetermined shape on a surface of the material layer;
forming a plurality of grooves on the surface of the material layer by etching the material layer exposed through the etch mask; and
depositing an anode electrode and a fluorescent layer sequentially on the surface of the material layer.

21. The method of claim 20, wherein the material layer is deposited by at least one of a group of printing and spin coating.

22. The method of claim 20, wherein the material layer comprises a transparent insulating material.

23. The method of claim 20, wherein forming the etch mask comprises:
applying a photoresist on the surface of the material layer; and
patterning the photoresist in a predetermined pattern by photolithography.

24. The method of claim 20, wherein etching the material layer is etched by at least one of a group of wet etching and dry etching.

25. The method of claim 20, wherein the grooves are substantially hemispherical.

26. The method of claim 20, further comprising isotropically etching the material layer exposed through the etch mask to obtain the grooves.

27. A method of manufacturing a panel for a field emission type backlight device, comprising:
providing a material layer on a substrate;
forming a plurality of grooves on a surface of the material layer by patterning the material layer by photolithography; and
providing an anode electrode and a fluorescent layer sequentially on a surface of the material layer.

28. The method of claim 27, wherein the material layer comprises a photosensitive insulating material.
